(19) United States
(12) Patent Application Publication
(10) Pub. No.: US 2005/0278766 A1
(43) Pub. Date: Dec. 15, 2005

(54) Wireless support for TV pay-per-view ordering

(76) Inventors: David S. Benco, Winfield, IL (US); Kevin J. Overend, Elmhurst, IL (US); Baoling S. Sheen, Naperville, IL (US); Sandra Lynn True, St. Charles, IL (US); Kenneth J. Voight, Sugar Grove, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/854,846

(22) Filed: May 27, 2004

(51) Int. Cl. H04N 7/173; H04N 7/18; H04N 7/16

(52) U.S. Cl. 725/104; 725/62; 725/78; 725/87

(57) ABSTRACT

A method for ordering TV PPV content is provided. The method includes: displaying PPV content that is available for ordering; receiving input indicating which PPV content is being order; generating PPV order information related to the PPV content ordered; and, communicating the PPV order information to an MS (40) served by a wireless telecommunications network.

### FIELD

The present inventive subject matter relates to the telecommunication arts. Particular application is found in conjunction with wireless mobile devices (e.g., mobile telephones and the like), and the specification makes particular reference thereto. However, it is to be appreciated that aspects of the present inventive subject matter are also amenable to other like applications.

### BACKGROUND

Subscribers to satellite and/or cable television (TV) are often provided one or more channels on which programming is provided on a pay-per-view (PPV) basis. To view a PPV program or content, the user typically orders the program or content prior to its start.

It has been deemed advantageous to make ordering of pay-per-view content quick and efficient for the user ordering it. Accordingly, cable boxes and satellite TV receivers are often equipped to permit on-screen PPV ordering. Typically, the cable box and/or satellite TV receiver is provisioned with a standard telephone jack into which a telephone line is connected. In many households, this telephone line is the same one used for other purposes, e.g., voice calls, Internet connections, etc.

To order PPV content, a user is provided with on-screen prompts, menus and/or options from which to select. Using a remote control or other input device, the user selects the appropriate items to order the desired PPV program or content. In response, the cable box or satellite TV receiver places a call over the connected telephone line to a system which processes the order.

While generally acceptable, the foregoing approach has certain limitations and/or drawbacks. For example, a problem is encounter if ordering is attempted when the telephone line is otherwise occupied, e.g., with a voice call or Internet connection. One solution would be to employ a dedicated telephone line for PPV ordering. However, this solution is cost prohibitive for many households. Moreover, it is an inefficient use of resources insomuch as PPV ordering is typically intermittent. Larger time gaps of inactivity in this respect means the dedicated telephone line would be utilized too infrequently to justify its expense.

Additionally, a telephone line may not be readily accessible from the desired location of the cable box and/or satellite TV receiver. Accordingly, a telephone line may have to be run to the cable box and/or satellite TV receiver. Otherwise, the location of the cable box and/or satellite TV receiver is limited to within reach of an existing telephone line.

Accordingly, a new and improved wireless approach to pay-per-view ordering is disclosed that overcomes the above-referenced problems and others.

### SUMMARY

In accordance with one preferred embodiment, a method for ordering TV PPV content is provided. The method includes: displaying PPV content that is available for ordering; receiving input indicating which PPV content is being ordered; generating PPV order information related to the PPV content ordered; and, communicating the PPV order information to a mobile station (MS) served by a wireless telecommunications network.

In accordance with another preferred embodiment, a system is provided for ordering of TV PPV content by a user. The system includes: means for displaying PPV content that is available for ordering; means for receiving input indicating which PPV content is being ordered; means for generating PPV order information related to the PPV content ordered; and, means for communicating the PPV order information to an MS served by a wireless telecommunications network.

In accordance with yet another preferred embodiment, a system is provided for ordering of TV PPV content by a user. The system includes: a receiver box operatively connected to a TV, the receiver box selectively displaying on the TV a menu listing the PPV content that is available for ordering; a control for the receiver box, the control operative to enter a selection from the menu of the PPV content the user desires to order, such that the receiver box generates PPV ordering information in response to the selection; and, a transmitter arranged to wirelessly transmit the PPV ordering information from the receiver box.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration of an exemplary system suitable for practicing aspects of the present inventive subject matter.

FIG. 2 is a flow chart showing an exemplary PPV ordering process embodying aspects of the present inventive subject matter.

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components that are commonly known in the art without further detailed explanation as to their configuration or operation except to the extent they have been modified or altered in accordance with and/or to accommodate the preferred embodiment(s) presented.

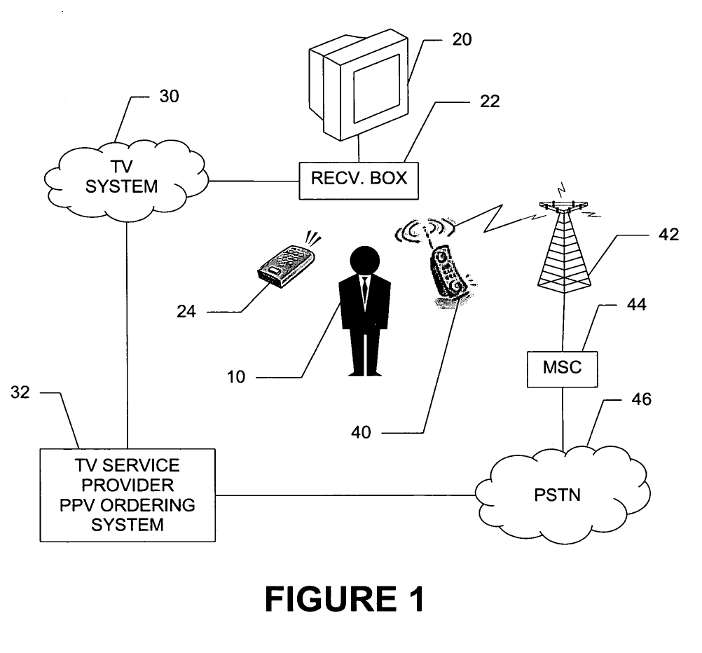

With reference to FIG. 1, a user is indicated by reference numeral 10. A TV 20 being viewed by the user 10 is operatively connected to a receiver box 22 in the usual manner. The receiver box 22 is optionally a satellite TV receiver or a cable box. The receiver box 22 is also operatively connected to the standard TV system and/or network 30 in the usual manner, e.g., via a cable network or satellite and satellite dish.

Suitably, a satellite or cable TV subscription is associated with the receiver box 22 in the usual manner such that one or more channels can be selected by the user 10 for viewing on the TV 20. One or more channels provided carry PPV programs and/or content. The receiver box 22 is equipped to provide an on-screen PPV ordering system.

Suitably, via the receiver box 22, a listing or menu of available PPV options are selectively provided and displayed on the TV 20. Using a wireless remote control 24 or other appropriate input device, the user 10 navigates through the listing or menu to select the PPV program or content that is to be ordered. In this manner, the PPV ordering is provided on-screen for easy and convenient use by the user 10.

A mobile device or mobile station (MS) 40 (e.g., a mobile telephone or other wireless mobile end user equipment) selectively connects with a wireless telecommunications network via a base station (BS) 42 served by a mobile switching center (MSC) 44 that connects to the public switched telephone network (PSTN) 46 in the usual manner. Suitably, the MS 10 is provisioned with the usual elements, e.g., a keypad with traditional numeric keys, soft keys, navigation keys, etc.; a liquid crystal display (LCD) or other such display; and, other components commonly found on or incorporated in a MS.

The MS 40 and the receiver box 22 are also wirelessly connected to be in operative communication with one another. Suitably, the wireless communication is established via a Bluetooth connection, a Wi-Fi connection, a wireless local-area network (WLAN) connection, or other similar short range wireless radio frequency (RF) connection. Alternately, the receiver box 22 and MS 40 communicate via an infrared connection. In any event, the receiver box 22 and MS 40 are each equipped accordingly, e.g., with appropriate RF and/or infrared transmitters and/or receivers, to support the particular connection type employed. Suitably, the connection is only established and/or maintained when communications are being transferred between the receiver box 22 and the MS 40.

In an alternate embodiment, the MS 40 (or the operative components thereof may be hardwired and/or built-into the receiver box 22. In this case, the MS 40 may be essentially dedicated to wirelessly placing PPV order calls. That is to say, optionally, the receiver box may itself be an MS served by the wireless telecommunications network.

When the user 10 orders a PPV program or content via the on-screen PPV ordering system, the receiver box 22 processes the order to generate PPV ordering information relevant to the ordered PPV content, and passes or otherwise communicates the relevant PPV ordering information to the MS 40 via the wireless connection between the receiver box 22 and the MS 40. In response to receiving the PPV ordering information from the receiver box 22, the MS 40 places a call the TV service provider's PPV ordering system 32 which is operatively connected to the PSTN 46. Suitably, the call is placed by the MS 40 silently or without otherwise alerting the user 10. Once the call is established between the MS 40 and the TV service provider's PPV ordering system 32, the ordering information is conveyed or otherwise communicated from the MS 40 to the system 32 such that the order can then be processed in the usual manner. Having completed communication of the ordering information, the call is then terminated.

Alternately, as opposed to sending the PPV ordering information to the MS 40 to prompt the MS 40 to the call with the system 32, the receiver box 22 may simply send a request to the MS 40 that the call be placed by the MS 40. Once the call is established between the MS 40 and the system 32, the PPV ordering information is then transmitted to the MS 40 from the receiver box 22, and in turn on to the system 32. Again, having received the PPV order information, the system 32 may process the order in the usual manner.

In accordance with one suitable embodiment, PPV order processing is not prevented or delayed if the MS 40 is otherwise in use at the time of ordering, e.g., if the user 10 is on a voice call with the MS 40 when an order is placed. If the MS 40 is otherwise engaged in a call when it is prompted to place the PPV ordering call, the MS 40 communicates the PPV ordering information over the wireless network via another channel, e.g., an uplink access or control channel, a different traffic channel, or the like. Suitably, the PPV ordering information is communicated in a text message format, e.g., as a short-message-service (SMS) message or the like.

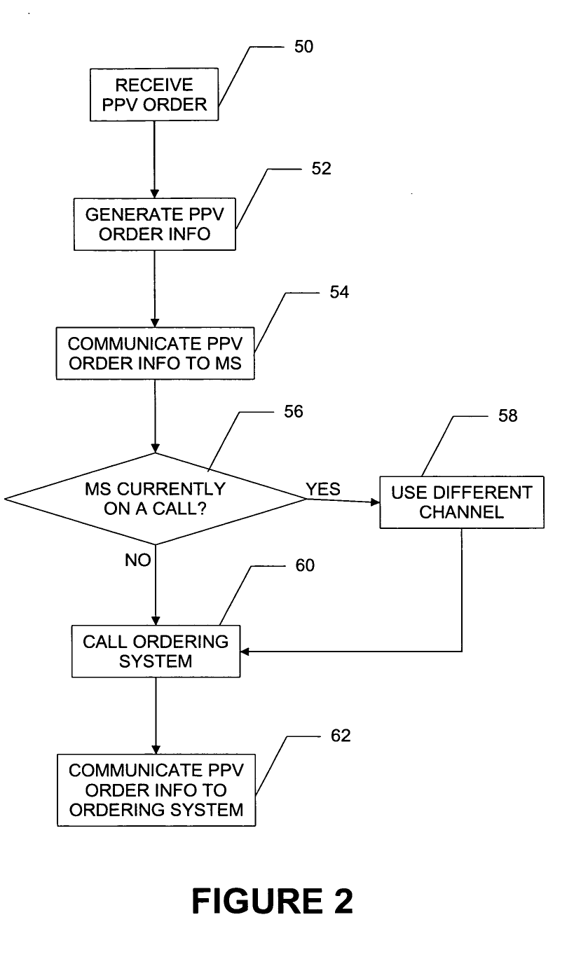

With reference to FIG. 2, the flow chart shows an exemplary PPV ordering process. At step 50, the receiver box 22 receives the PPV order, and at step 52, the PPV ordering information is generated. At step 54, the PPV ordering information is communicated to the MS 40 from the receiver box 22.

At decision step 56, it is determined if the MS 40 is currently engaged in a call. If the determination at decision step 56 is yes (i.e., the MS 40 is currently engaged in a call), then the process branches to step 58, where a different channel (i.e., different from the one the MS 40 is using for the call in which it is currently engaged) is selected for placing the PPV ordering call, and the process returns to step 60. Otherwise, if the determination at decision step 56 is no (i.e., the MS 40 is not currently engaged in a call), then the process flows directly to step 60. At step 60, the MS 40 calls the TV service provider's PPV ordering system 32, and at step 62, the PPV ordering information is communicated to the system 32.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

1. A method for ordering television (TV) pay-per-view (PPV) content, said method comprising:
(a) displaying PPV content that is available for ordering;
(b) receiving input indicating which PPV content is being ordered;
(c) generating PPV order information related to the PPV content ordered; and,
(d) communicating the PPV order information to a mobile station (MS) served by a wireless telecommunications network.

2. The method of claim 1, further comprising:
(e) placing a call with the MS over the wireless telecommunications network to a PPV order processing system; and,
(f) communicating the PPV order information to the PPV order processing system via the placed call.

3. The method of claim 1, wherein the communicating of step (d) is carried out over a wireless connection.

4. The method of claim 4, wherein the wireless connection is selected from a Bluetooth connection, a Wi-Fi connection, a wireless local-area network (WLAN) connection, or an infrared connection.

5. The method of claim 2, further comprising:
determining if the MS is engaged in another call prior to step (e); and,
placing the call of step (e) on a different channel when the MS is engaged in another call.

6. The method of claim 2, wherein the PPV order information is communicated to the PPV order processing system as a text message.

7. The method of claim 6, wherein the text message is a short-message-service (SMS) message.

8. A system that provides for ordering of television (TV) pay-per-view (PPV) content by a user, said system comprising:
means for displaying PPV content that is available for ordering;
means for receiving input indicating which PPV content is being order;
means for generating PPV order information related to the PPV content ordered; and,
means for communicating the PPV order information to a mobile station (MS) served by a wireless telecommunications network.

9. A system that provides for ordering of television (TV) pay-per-view (PPV) content by a user, said system comprising:
a receiver box operatively connected to a TV, said receiver box selectively displaying on said TV a menu listing the PPV content that is available for ordering;
a control for the receiver box, said control operative to enter a selection from the menu of the PPV content the user desires to order, such that the receiver box generates PPV ordering information in response to the selection; and,
a transmitter arranged to wirelessly transmit the PPV ordering information from the receiver box.

10. The system of claim 9, further comprising:
a mobile station (MS) served by a wireless telecommunications network, said MS having a receiver that receives the PPV ordering information transmitted by the transmitter.

11. The system of claim 10, wherein the MS places a call over the wireless telecommunications network to a PPV ordering system, and communicates the PPV ordering information to the PPV ordering system via said call such that the PPV ordering system can process the PPV order.

12. The system of claim 11, wherein the transmitter is an infrared transmitter and the receiver is an infrared receiver.

13. The system of claim 11, wherein the transmitter is a radio frequency (RF) transmitter and the receiver is an RF receiver.

14. The system of claim 13, wherein the receiver box communicates with the MS via a connection selected from a Bluetooth connection, a Wi-Fi connection, or a wireless local-area network (WLAN) connection.

15. The system of claim 9, wherein the receiver box is selected from a cable box or a satellite TV receiver.

16. The system of claim 9, wherein the control is a wireless remote control.
